(19) United States
(12) Patent Application Publication
(10) Pub. No.: US 2022/0147583 A1
(43) Pub. Date: May 12, 2022

(54) SYSTEM AND METHOD FOR QUALITY BASED RANKING OF PATENTS

(71) Applicants: ERICH LAWSON SPANGENBERG, PARIS (FR); DANIEL LAWRENCE BORK, EAST KINGSTON, NH (US); PASCAL ASSELOT, PARIS (FR); BRIAN JOSHUA BERMAN, LONG ISLAND CITY, NY (US); GEORGE KARYPIS, BLOOMINGTON, MN (US)

(72) Inventors: ERICH LAWSON SPANGENBERG, PARIS (FR); DANIEL LAWRENCE BORK, EAST KINGSTON, NH (US); PASCAL ASSELOT, PARIS (FR); BRIAN JOSHUA BERMAN, LONG ISLAND CITY, NY (US); GEORGE KARYPIS, BLOOMINGTON, MN (US)

(21) Appl. No.: 17/499,779

(22) Filed: Oct. 12, 2021

Related U.S. Application Data
(63) Continuation of application No. 16/257,006, filed on Jan. 24, 2019, now abandoned.
Application No. 16/257,006 is a continuation of application No. 16/216,776, filed on Dec. 11, 2018, now abandoned.
Application No. 16/216,776 is a continuation-in-part of application No. PCT/US18/56690, filed on Oct. 19, 2018.
Application No. PCT/US18/56690 is a continuation-in-part of application No. PCT/US18/56884, filed on Oct. 22, 2018.
Application No. PCT/US18/56884 is a continuation-in-part of application No. PCT/US18/57062, filed on Oct. 23, 2018.
Application No. PCT/US18/57062 is a continuation-in-part of application No. PCT/US18/61448, filed on Nov. 16, 2018.
Application No. PCT/US18/61448 is a continuation-in-part of application No. PCT/US18/64186, filed on Dec. 6, 2018.
(60) Provisional application No. 62/622,922, filed on Jan. 28, 2018.
(60) Provisional application No. 62/622,994, filed on Jan. 29, 2018.
(60) Provisional application No. 62/660,946, filed on Apr. 21, 2018.
(60) Provisional application No. 62/672,687, filed on May 17, 2018.
(60) Provisional application No. 62/685,299, filed on Jun. 15, 2018.
(60) Provisional application No. 62/685,937, filed on Jun. 16, 2018.
(60) Provisional application No. 62/685,960, filed on Jun. 16, 2018.
(60) Provisional application No. 62/689,241, filed on Jun. 24, 2018.
(60) Provisional application No. 62/695,002, filed on Jul. 7, 2018.
(60) Provisional application No. 62/695,126, filed on Jul. 8, 2018.
(60) Provisional application No. 62/696,357, filed on Jul. 11, 2018.

(51) Int. Cl. G06F 16/953; G06F 16/93; G06F 16/2457; G06Q 50/18

(52) U.S. Cl. CPC G06F 16/953; G06F 16/93; G06F 2216/11; G06Q 50/184; G06F 16/24578

(57) ABSTRACT

Qscore is the most advanced tool available for ranking the potential commercial value of a patent or a portfolio of patents. Other ranking methods typically rely heavily on a patent's reference graph (citations to/from other patents). Qscore is far more sophisticated: using data mining tokenization techniques, Qscore takes into account multiple factors correlated with patent value. This document generally describes the method used to assign a quality score to each patent, which is used to bias the ranking of the results returned from the keyword-based searching in the analytics embodiment of the present invention. This quality score, denoted by Qscore, is designed to identify the patents that are not only relevant to the user's query but also possess some additional, query independent, quality characteristics. Consequently, Qscore can be considered as an information filtering aid—designed to identify the “good” information from a “sea” of information.

### PRIORITY CLAIMS

This application is a continuation of U.S. application Ser. No. 16/257,006, filed Jan. 24, 2019, which claims the benefit of: U.S. Provisional Patent Application No. 62/622,922, filed Jan. 28, 2018; U.S. Provisional Patent Application No. 62/622,994, filed Jan. 29, 2018; International Patent Application Number PCT/US2018/56690, filed on Oct. 19, 2018; International Patent Application Number PCT/US2018/56884, filed on Oct. 22, 2018; International Patent Application Number PCT/US2018/57062, filed on Oct. 23, 2018; International Patent Application Number PCT/US2018/59174, filed on Nov. 5, 2018; International Patent Application Number PCT/US2018/61448, filed on Nov. 16, 2018; International Patent Application Number PCT/US2018/64186, filed on Dec. 6, 2018; U.S. patent application Ser. No. 16/216,776, filed Dec. 11, 2018; U.S. Provisional Patent Application No. 62/660,946, filed Apr. 21, 2018; U.S. Provisional Patent Application No. 62/672,697, filed May 17, 2018; U.S. Provisional Patent Application No. 62/685,299, filed Jun. 15, 2018; U.S. Provisional Patent Application No. 62/685,937, filed Jun. 16, 2018; U.S. Provisional Patent Application No. 62/685,960, filed Jun. 16, 2018; U.S. Provisional Patent Application No. 62/689,241, filed Jun. 24, 2018; U.S. Provisional Patent Application No. 62/695,002, filed Jul. 7, 2018; U.S. Provisional Patent Application No. 62/695,126, filed Jul. 8, 2018; and U.S. Provisional Patent Application No. 62/696,357, filed Jul. 11, 2018, each of which is incorporated herein.

### BACKGROUND

### Field of the Invention

This invention deals with patent searching and patent analysis.

### Background of the Invention

There is a need for a patent analysis tool that produces a patent quality score. This is different than a patent validity score.

### SUMMARY OF INVENTION

The present invention is an online/wireless worldwide patent search and analytics tool. The present invention was developed through the use of artificial intelligence, predictive analytics, database management and machine learning experts. The present invention includes both patent and non-patent literature (NPL) searching.

The analytics embodiment of the present invention presents for users a single score that is designed to measure the overall relative quality of a patent in a large patent collection by taking into account various attributes, including the citation network of the collection and a measure of value that the patent owners assign to it. We call this score the “Qscore.”

This invention generally describes the method used to assign a Qscore to each U.S. Patent, which is used to bias the ranking of the results returned from the keyword-based searching in the analytics embodiment of the present invention. (Unless otherwise specified, the term “patent” is used to refer to both U.S. Patents and Applications. Similar methodology is utilized for non-US patents but this document focuses only on US patents.) This quality score, denoted by Qscore, is designed to identify the patents that are not only relevant to the user's query but also possess some additional, query independent, quality characteristics. Consequently, Qscore can be considered as an information filtering aid—designed to identify the “good” information from a “sea” of information.

Qscore is the most advanced tool available for ranking the potential commercial value of a patent or a portfolio of patents. Other ranking methods typically rely heavily on a patent's reference graph (citations to/from other patents). Qscore is far more sophisticated: using data mining tokenization techniques, Qscore takes into account multiple factors correlated with patent value.

The Qscore is computed by performing a random walk with restart, in which the destination of the random walk's restart node is proportional to the values assigned to the patents by their owners. The steady-state probabilities of ending up at any given node in the network of that random walk are used to determine the Qscore of each node. Nodes with higher steady-state probabilities will in general have higher Qscores than nodes with smaller steady-state probabilities. Extensive research in using random walks on networks have shown that the nodes with high steady-state probabilities correspond to central nodes in the network and depending on the underlying domain, they correspond to topical authorities (e.g., performing a random walk on the citation network of scientific articles), important web-pages (e.g., performing a random walk on the network corresponding to the hyperlink structure of the web), proteins involved in many biological processes (e.g., performing a random walk in a protein-protein interaction network), and influencers (e.g., performing a random walk in a social network or a follower-followee network).

The Qscore is computed using the following process. A directed weighted network is constructed from the collections' citations. In that network, each patent in the collection forms a node, and every time a patent x cites patent y, a pair of weighted edges are created from x to y and from y to x. Each node is assigned an initial weight that corresponds to the number of times that a patent has been active. This initial weight corresponds to patent owner's assigned measure of value as it correlates to the costs associated with prosecuting and maintaining the patent. The initial node weights are scaled to form a probability distribution, and the weighted directed network is converted into a row-stochastic matrix. Random-walk with restart is performed on this network to compute the steady-state probabilities that a random walked will end up at any given node. The steady-state probability of each patent is then divided by the average steady-state probability of the patents that were published in the prior two years. A standard logistic function is then used to convert these ratios into a probability value, which is then scaled to a number between 0 and 100.

To address the issue that in a citation network, older sources tend to accumulate more citations, the weighted network used for Qscore reduces the weight of the source-destination links in which the publication date of the source is more recent than that of the destination based on the publication time difference of the two nodes. For similar reasons, it increases the weight of the source-destination links when the date of the source is older than that of the destination based on the publication time difference. This reduces the tendency of older patents to have higher Qscore values just because they are older. However, since it usually takes a few years for newly published patents to be well-connected in the network, the reliability of the Qscore values for recently published patents is expected to be lower.

The Qscore values for individual patents are used to compute a Qscore for the patents that belong to the same patent family. This family-based Qscore value is computed either as the mean of the family's constituent Qscores or as the maximum of the family's constituent Qscores. The algorithms used for determining Qscores are based on the USPTO maintenance fees. However, similar algorithms can be used for worldwide Patent Offices in any country.

An additional embodiment of the present invention is a social networking and collaboration feature. There will be communications capabilities so patent searchers could communicate or talk to one another—privately or publically. There will be a feature, wherein all of the worldwide Patent Examiners and/or patent searchers can easily collaborate with each other, including instant messenger, video conference, phone, email, live chat, etc.

The Patent Searchers can save their patent search strategies. That way, other people can review, modify, and improve their search strategies. For example, some patent searchers in other countries could use the same search strategies, after translating the customized search queries into their native home country languages. Likewise, third parties could also use social networking/collaboration features to assist each other with their crowdsourced patentability searches.

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor.

Another embodiment of the present invention is the Patent Analytics Platform. This platform is a blockchain-based Registry that contains high-level metadata on each patent. The blockchain record for each patent will link to the present invention, where the full text of the patent (including diagrams) and a wealth of analytic information will be available to view or download.

The present invention will continually add patents from additional countries in order to eventually capture every patent in the world. The present invention will also allow for developers to capture our data via API for integration into other systems. Sophisticated users won't be limited to the user interface of the present invention. The present invention also includes tools for claims analysis, in-depth analysis of individual patents, and comparative analysis of a portfolio of patents.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 is an illustration depicting an exemplary operating environment including one or more user computers, computing devices, or processing devices, which can be used to operate a client, such as a dedicated application, web browser is shown.

FIG. 2 is another illustration depicting an exemplary operating environment including a computer system with various elements as shown.

FIG. 3 is an illustration of one aspect of the present invention.

### DETAILED DESCRIPTION OF INVENTION

The current approach for computing Qscore takes into account the following information:
a) the citation graph of the patents;
b) the similarity between the claims and the specs of citing and cited patents;
c) how well the claims of a patent are supported by its specification;
d) the age difference between citing and cited patents;
e) the primary art area and art class that the patents belong to;
f) the extended families of the patents (as determined by the analytics embodiment of the present invention);
g) the patents' initial assignees; and
h) the maintenance payment history.

The overall approach is based on an informed-walk model and the final score depends on the steady-state probability of an informed walker ending up at a certain patent by traversing a graph whose nodes correspond to the patents and the edges are determined by the citations. The informed-walk model behaves as follows. A user starts at a certain page, then with some degree of probability, he will do one of the following:
1. Walk to one of the patents that the current patent cites.
2. Walk to one of the patents that cite the current patent.
3. Walk to a randomly selected patent from the universe of patents according to a probability distribution.

This informed-walk model assumes that at any given point, the user makes critical decisions as to which patents the user will visit next based on various characteristics of the patent that the user is currently on and the patent that the user is considering visiting. In addition, item 2 in the informed-walk model is motivated by the observation that an informed walker (e.g., sophisticated researcher), once he/she finds something good, he/she also visits some of the patents that cite the current patent in order to identify the current state-of-the-art or how the technology has evolved/been used over the years.

The informed-walk model is used for computing Qscore due to the fact that patents have a weight associated with them. These weights, which can depend on the intrinsic value that a patent owner puts on a patent, as measured for example by the length of the patent prosecution period and the payment of maintenance fees, are used to positively influence the initial probabilities of visiting a patent and also the selection probabilities influencing item 3 in the above model.

The various parameters of the informed-walk model are encoded in a form of a graph G=(V, E), connecting the various patents. The nodes of this graph (V) are the patents and the edges (E) correspond to the patents that are cited by and are citing each patent. In addition, each node has a self-edge (i.e., connects to itself) that is used to capture an intrinsic measure of patent quality. This is motivated by the observation that, by virtue of its issuance by a Patent Office, it was necessarily exposed to a review

TABLE 1
Scheme used to assign weights to
nodes based on maintenance fees.

| Type of patent | Weight |
|---|---|
| Failed to pay 4^{th} year fee | 1 |
| Failed to pay 8^{th} year fee | 2 |
| Failed to pay 12^{th} year fee | 4 |
| Expired due to age | 8 |
| Young patent (<4 years) | 1 |

Algorithm 1. Method for determining edge strength

| | |
|---|---|
| 1. | points(v, u) = 1 |
| 2. | points(v, u) += 2, if v and u belong to the same primary art area. |
| 3. | points(v, u) += 4, if v and u belong to the same classification |
| | (fine-grain). |
| 4. | points(v, u) += 2, if v and u belong to different extended patent |
| | families. |
| 5. | points(v, u) += 2, if v and u have different initial assignees. |

process by a patent examiner. This self-edge also serves a practical purpose as it allows each patent to maintain some level of a Qscore during the informed walk process in those cases in which a patent is not citing or is not being cited by any other patents. The graph has weights associated to both its nodes and edges. These weights are used to derive the probabilities that the adjacent nodes will be visited and are the fundamental mechanism by which the “informed” aspect of the informed-walk model is achieved.

The node weights measure the importance of each patent and can be determined based on the number of patent office actions requiring a response by the prosecuting team and the maintenance fee payments. The weights based on the maintenance fee payments are determined according to the approach shown in Table 1. The weights based on the patent office actions are determined based on the ratio (r) of the number of actions required by a patent over the average number of patent actions. The value of r is then scaled so to be in the same range as the maintenance-fee based weigh (e.g., to be between 1 and 8)t. For those patents for which no patent office action information is available, a fixed weight is assigned to them that is the median value of the weights assigned to the rest of the patents. These two weights are added up to come up with the combined weight. Once these weights have been computed, they are normalized so that they add to 1.0. Additional indicators of importance are currently incorporated and will be incorporated in future versions of the model.

Different schemes are used to assign weights to the three types of edges (self-edge, citing edges, cited-by edges). The weight of each citing edge, i.e., an edge that connects a patent v with a patent u such that v cites u (u is in the “References Cited” section of v's patent) is given by where points(v, u) is determined based on Algorithm 1 AgeDiff(v, u) is the difference in days between the issue dates of the v and u patents, and csim(v, u) is the average similarity between v's independent claims and u's specification (alternatively, it can be defined as the max similarity between any of v's claims to u's specification). The method for computing points(v, u) gives higher importance to a cited patent that
(i) belongs to the same primary art area and classification with the citing patent and
(ii) has not originated from the same initial invention or entity as the citing patent.

This weighting is motivated by the following observations/assumptions:
(i) An informed walker will most likely read a patent that belongs to the same topic area with the current patent, since that patent will be more directly related to the current patent's topic.
(ii) An informed walker will most likely not read a patent that belongs to the same family because that patent will provide little additional information.
(iii) A citation to a patent that has a different initial assignee has higher importance as it is an indicator that two separate parties (the original assignee and the citing assignee) believe the subject of the invention is important.
(iv) Citations to patents belonging to the same assignee/family may have been included for self-promotional purposes.

$${w}_{v , u} = \frac{points ( v , u )}{5 \times 365 + A g eDiff ( v , u )} \times csim ( v , u ) , \qquad EQUATION 1$$

The use of AgeDiff(v, u) is designed to give higher emphasis to cited patents that were issued more recently. These patents will better reflect the recent state-of-the-art, and as such they will be preferred by an informed walker. Note that 5×365 in Equation 1 is used to dampen the impact of the inverse relation on AgeDiff(v,u). The method for computing csim(v,u) employs a sliding-window approach in which it tries to identify the region in the specification that best describes the independent claims being compared. The motivation behind the use of csim(v,u) is to give higher importance to those citations in which the claim relates to what the citing patent teaches and less importance to those citations that are not directly related to the claims of the citing patent (e.g., citations that exist as an example of an approach used to implement a preferred embodiment but it is not directly related to what is actually being claimed).

$${w}_{v , u} = \frac{points ( v , u ) ( 5 \times 365 + A g eDiff ( v , u ) )}{{d}_{u}} \times r c n c y ( u ) \times c s i m ( u , v ) , \qquad EQUATION 2$$

The weight of each cited-by edge, i.e., an edge that connects a patent v with a patent u such that u cites v (v is in the “References Cited” section of u's patent) is given by where points(v, u), and AgeDiff(v, u), and csim(u, v) are as before, dᵤ is the number of patents that u cites, and “rcncy” (u) is given by

$$rcncy ( u ) = f ( \frac{8 \times 365}{NOW - IssueD a t e ( u )} ) ,$$

where ƒ( ) is a monotonically increasing function. Note that unlike the citing edges, the weight of the cited-by edges is positively related on the AgeDiff(v, u). This is in order to give higher weight (i.e., importance) to the most recent patents that cite v, with the rationale being that these more recent patents are better representatives of the current state-of-the-art and as such they will be preferred by an informed walker. Also, the weight of each edge is inversely proportional to the number of patents that u cites. The rationale for that is to de-emphasize edges to patents that cite a very large number of other patents. An alternate way of thinking of the use of the dᵤ factor is to de-emphasize patents that are the equivalent of review papers, which tend to cite a large number of other papers. (We continue to evaluate modifications to the informed-walker model we have deployed. We are currently performing user studies to further determine if we are able to provide additional support for various aspects of the model.) Also, this down-weighting factor has a practical benefit for guarding against patents that try to artificially get themselves scored high by simply citing a very large number of patents. The rcncy(u) term is to give higher importance to the most recent citations, and it is determined with respect to the current time point (i.e., NOW).

The weight of the self-edge is

$$\frac{6}{5 \times 365} \times csim ( v , v )$$

and is derived directly from Equation 1. Note that the use of csim(v, v) in the above equation will give higher importance to the patents whose claims are well supported by the specification. An alternate model will be to use csim(v, v) as an additional parameter in assigning weights to the nodes. Note that the durations of 5 and 8 years that are used in the above calculations are just one possible set of weights for dampening/smoothing the small and large temporal differences (often referred to as Laplace corrections), and different durations can also be used.

The importance of the citing and cited-by types of edges relative to each other is determined by an external parameter. In the current version, this is set so that the citing edges account for the 75% of the weights and the cited-by account for the remaining 25%. For the purpose of these computations, the self-edge is considered to belong to the first group of edges (i.e., citing edges).

The steady-state probabilities computed by the informed-walk model are further normalized in order to eliminate any biases that may exist towards older patents. This normalization is performed by dividing the steady-state probability for patent v, with the average of the steady-state probabilities over all the patents that were issued in a 720-day window centered on v's issue date. The resulting temporally-normalized steady-state probabilities, pᵥ, are further transformed by taking their log₂(pᵥ) value. Finally, the positive range of the log₂(pᵥ) values are scaled to be between (0.5 . . . 1.0) and the negative range of the log₂(pᵥ) values are scaled to be between (0.0 . . . 0.5). These scaled values correspond to the Qscore values of the patents. Alternatively, the temporally normalized weights can be converted into normalized scores in the range of 1 to 100 by using a logistic function.

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The units described above can be implemented as software components executing on one or more general purpose processors, as hardware such as programmable logic devices and/or Application Specific Integrated Circuits designed to perform certain functions or a combination thereof. In some embodiments, the units can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices. The functions of the units may be merged into one another or further split into multiple sub-units.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

Persons of ordinary skill in the art are able to understand that all or portions of the steps in the embodiments described above may be realized using programs instructing the relevant hardware, and said programs can be stored on computer-readable storage media, such as a read-only memory, hard disk or compact disc. Optionally, all or portions of the steps of the embodiments described above may also be realized using one or multiple integrated circuits. Accordingly, the various modules/units contained in the embodiments above may also be realized in the form of hardware or software function modules. Thus, the present application is not limited to any specific combination of hardware and software.

The present application may have a variety of other embodiments and, without departing from the spirit and substance of the present application, persons skilled in the art may produce a variety of corresponding changes and modifications based on the present application, but these corresponding changes and modifications shall all fall within the scope of protection of the claims of this application.

Although the foregoing embodiments have been described in some detail for purposes of clarity of understanding, the invention is not limited to the details provided. There are many alternative ways of implementing the invention. The disclosed embodiments are illustrative and not restrictive.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

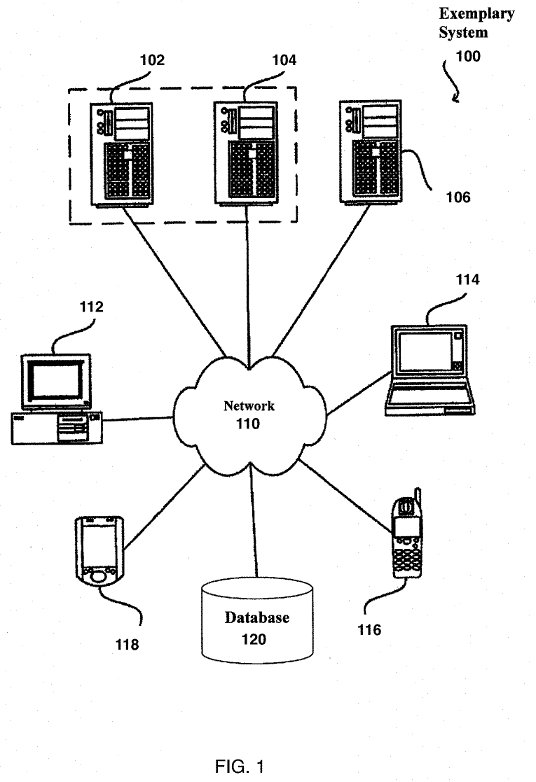

FIG. 1 is a block diagram illustrating components of an exemplary operating environment in which embodiments of the present invention may be implemented. The system 100 can include one or more user computers, computing devices, or processing devices 112, 114, 116, 118, which can be used to operate a client, such as a dedicated application, web browser, etc. The user computers 112, 114, 116, 118 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 112, 114, 116, 118 may also have any of a variety of applications, including one or more development systems, database client and/or server applications, and Web browser applications. Alternatively, the user computers 112, 114, 116, 118 may be any other electronic device, such as a thin-client computer, Internet-enabled gaming system, and/or personal messaging device, capable of communicating via a network (e.g., the network 110 described below) and/or displaying and navigating Web pages or other types of electronic documents. Although the exemplary system 100 is shown with four user computers, any number of user computers may be supported.

In most embodiments, the system 100 includes some type of network 110. The network can be any type of network familiar to those skilled in the art that can support data communications using any of a variety of commercially-available protocols, including without limitation TCP/IP, SNA, IPX, AppleTalk, and the like. Merely by way of example, the network 110 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 102, 104, 106 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 106) may be dedicated to running applications, such as a business application, a Web server, application server, etc. Such servers may be used to process requests from user computers 112, 114, 116, 118. The applications can also include any number of applications for controlling access to resources of the servers 102, 104, 106.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 112, 114, 116, 118. As one example, a server may execute one or more Web applications. The Web application may be implemented as one or more scripts or programs written in any programming language, such as Java®, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 112, 114, 116, 118.

The system 100 may also include one or more databases 120. The database(s) 120 may reside in a variety of locations. By way of example, a database 120 may reside on a storage medium local to (and/or resident in) one or more of the computers 102, 104, 106, 112, 114, 116, 118. Alternatively, it may be remote from any or all of the computers 102, 104, 106, 112, 114, 116, 118, and/or in communication (e.g., via the network 110) with one or more of these. In a particular set of embodiments, the database 120 may reside in a storage-area network (“SAN”) familiar to those skilled in the art. Similarly, any necessary files for performing the functions attributed to the computers 102, 104, 106, 112, 114, 116, 118 may be stored locally on the respective computer and/or remotely, as appropriate. In one set of embodiments, the database 120 may be a relational database, such as Oracle 10g, that is adapted to store, update, and retrieve data in response to SQL-formatted commands.

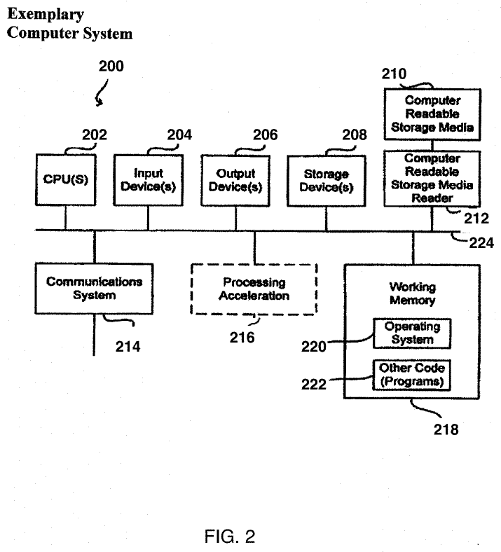

FIG. 2 illustrates an exemplary computer system 200, in which embodiments of the present invention may be implemented. The system 200 may be used to implement any of the computer systems described above. The computer system 200 is shown comprising hardware elements that may be electrically coupled via a bus 224. The hardware elements may include one or more central processing units (CPUs) 202, one or more input devices 204 (e.g., a mouse, a keyboard, etc.), and one or more output devices 206 (e.g., a display device, a printer, etc.). The computer system 200 may also include one or more storage devices 208. By way of example, the storage device(s) 208 can include devices such as disk drives, optical storage devices, solid-state storage device such as a random-access memory (“RAM”) and/or a read-only memory (“ROM”), which can be programmable, flash-updateable and/or the like.

The computer system 200 may additionally include a computer-readable storage media reader 212, a communications system 214 (e.g., a modem, a network card (wireless or wired), an infra-red communication device, etc.), and working memory 218, which may include RAM and ROM devices as described above. In some embodiments, the computer system 200 may also include a processing acceleration unit 216, which can include a digital signal processor DSP, a special-purpose processor, and/or the like.

The computer-readable storage media reader 212 can further be connected to a computer-readable storage medium 210, together (and, optionally, in combination with storage device(s) 208) comprehensively representing remote, local, fixed, and/or removable storage devices plus storage media for temporarily and/or more permanently containing, storing, transmitting, and retrieving computer-readable information. The communications system 214 may permit data to be exchanged with the network and/or any other computer described above with respect to the system 200.

The computer system 200 may also comprise software elements, shown as being currently located within a working memory 218, including an operating system 220 and/or other code 222, such as an application program (which may be a client application, Web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and nonvolatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

FIG. 2 further illustrates an environment where an on-demand distributed database service might be used. As illustrated in FIG. 2 user systems might interact via a network with an on-demand database. Some on-demand databases may store information from one or more records stored into tables of one or more distributed database images to form a database management system (DBMS). Accordingly, on-demand database and system will be used interchangeably herein. A database image may include one or more database objects. A relational database management system (RDMS) or the equivalent may execute storage and retrieval of information against the database object(s). Some on-demand database services may include an application platform that enables creation, managing and executing one or more applications developed by the provider of the on-demand database service, wherein users accesses the on-demand database service via user systems, or third-party application developers access the on-demand database service via user systems.

The security of a particular user system might be entirely determined by permissions (permission levels) for the current user. For example, where a user account identification transaction may involve a portable identification alpha-numeric data field physically or digitally linked to a personal primary identification device to request services from a provider account and wherein the user is using a particular user system to interact with System, that user system has the permissions allotted to that user account. However, while an administrator is using that user system to interact with System, that user system has the permissions allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different permissions with regard to accessing and modifying application and database information, depending on a user's security or permission level.

A network can be a LAN (local area network), WAN (wide area network), wireless network, point-to-point network, star network, token ring network, hub network, or other appropriate configuration. As the most common type of network in current use is a TCP/IP (Transfer Control Protocol and Internet Protocol) network such as the global internetwork of networks often referred to as the “Internet” with a capital “I,” that will be used in many of the examples herein. However, it should be understood that the networks that the present invention might use are not so limited, although TCP/IP is a frequently implemented protocol.

User systems might communicate with a system using TCP/IP and, at a higher network level, use other common Internet protocols to communicate, such as HTTP, FTP, AFS, WAP, etc. In an example where HTTP is used, a user system might include an HTTP client commonly referred to as a “browser” for sending and receiving HTTP messages to and from an HTTP server at System. Such HTTP server might be implemented as the sole network interface between a system and network, but other techniques might be used as well or instead. In some implementations, the interface between a system and network includes load sharing functionality, such as round-robin HTTP request distributors to balance loads and distribute incoming HTTP requests evenly over a plurality of servers. At least as for the users that are accessing that server, each of the plurality of servers has access to at least one third party entity system data schema; however, other alternative configurations are contemplated.

According to one arrangement, each user system and all of its components are operator configurable using applications, such as a browser, including computer code run using a central processing unit such as an Intel Pentium® processor or the like. Similarly, a computer system (and additional instances of an enterprise database, where more than one is present) and all of their components might be operator configurable using application(s) including computer code run using a central processing unit such as an Intel Pentium® processor or the like, or multiple processor units. A computer program product aspect includes a machine-readable storage medium (media) having instructions stored thereon/in which can be used to program a computer to perform any of the processes of the embodiments described herein. Computer code for operating and configuring systems to intercommunicate and to process web pages, applications and other data and media content as described herein is preferably downloaded and stored on a hard disk, but the entire program code, or portions thereof, may also be locally stored in any other volatile or nonvolatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a client system and/or server or server system such as, for example, in C, C++, HTML, any other markup language, Java™, JavaScript, ActiveX, any other scripting language such as VBScript, and many other programming languages as are well known. (Java™ is a trademark of Sun Microsystems, Inc.).

A block chain or blockchain is a distributed database that maintains a list of data records, the security of which is enhanced by the distributed nature of the block chain. A block chain typically includes several nodes, which may be one or more systems, machines, computers, databases, data stores or the like operably connected with one another. In some cases, each of the nodes or multiple nodes are maintained by different entities. A block chain typically works without a central repository or single administrator. One well-known application of a block chain is the public ledger of transactions for cryptocurrencies such as used in bitcoin. The data records recorded in the block chain are enforced cryptographically and stored on the nodes of the block chain.

A block chain provides numerous advantages over traditional databases. A large number of nodes of a block chain may reach a consensus regarding the validity of a transaction contained on the transaction ledger.

The blockchain typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person), and blocks are created by users known as “miners” who use specialized software/equipment to create blocks. In some embodiments, the block chain system disclosed, SS the number of miners in the current system are known and the system comprises primary sponsors that generate and create the new blocks of the system. As such, any block may be worked on by a primary sponsor. Users of the block chain create transactions that are passed around to various nodes of the block chain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases, that meets other criteria.

In one embodiment, the Network is made up of a plurality of nodes, each node connected to another node in the plurality of nodes, having the ability to pass data to each of the connected plurality of nodes. At least one node of the plurality of nodes is connected to an existing blockchain. Using this existing blockchain, the decentralized transactions can take place.

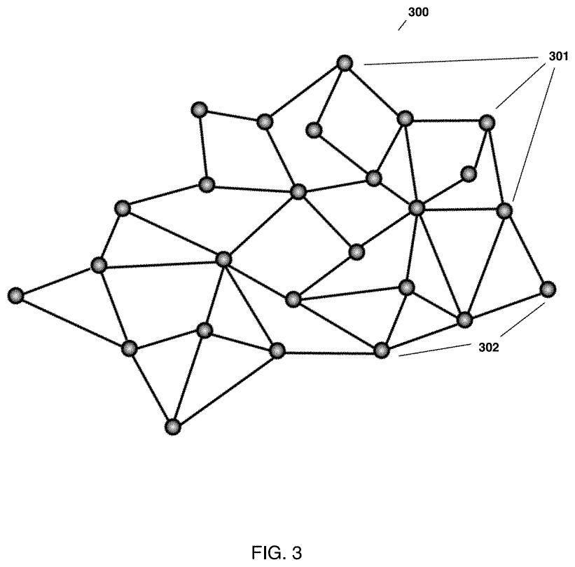

FIG. 3 depicts one aspect of the present invention. Specifically, the illustration shows the interconnection of each node 301 in a distributed decentralized network 300. In accordance with the preferred embodiment of the present invention, each node 301 in the distributed network 300 is directly connected to at least two other nodes 302. This allows each node 301 to transact with at least one other node 301 in the network.

The above illustrations provide many different embodiments for implementing different features of the invention. Specific embodiments of components and processes are described to help clarify the invention. These are, of course, merely embodiments and are not intended to limit the invention from that described in the claims.

Persons of ordinary skill in the art will realize that the foregoing description is illustrative only and not in any way limiting. Other modifications and improvements will readily suggest themselves to such skilled persons having the benefit of this disclosure.

While embodiments and applications of this disclosure have been shown and described, it would be apparent to those skilled in the art that many more modifications and improvements than mentioned above are possible without departing from the inventive concepts herein. The disclosure, therefore, is not to be restricted except in the spirit of the appended claims.

1. A system for evaluating a value a patent comprising:
at least one hardware processor, a non-transitory machine-readable storage medium having an executable computer readable program code, the at least one hardware processor configured to execute the computer-readable program code to:
access a plurality of databases, at least one of the plurality of databases containing patent related information;
search on at least one of the plurality of databases;
determine the number of times a subject patent is cited by at least one prior art patent reference and store in memory said number of times a subject patent is cited;
compare patent claims in at least one prior art patent reference and the subject patent;
determine an age of at least one prior art patent reference and the subject patent;
determine a classification of at least one prior art reference and the subject patent;
determine a maintenance fee status of the subject patent; and
determine assignees of the at least one prior art reference and the subject patent, wherein maintenance payment history is used to generate a model so a user may make critical decisions as to what patents said user may next visit and so historical patent value results may be evaluated by said hardware processor so that a user may be able to establish a patent value.

2. The system of claim 1, further configured to determine a weight for the subject patent based on its age, citing references, classification, maintenance fee status, and assignees.

3. The system of claim 1, configured to compare the age of the subject patent and the age of at least one prior art reference.

4. The system of claim 1, wherein the system is configured to determine the weight of the subject patent based on the difference in age between the subject patent and at the at least one prior art reference.

5. The system of claim 1, configured to determine the weight of the subject patent, wherein the weight is based on at least one prior art reference, and the age difference between the at least one prior art reference and the subject patent.

6. The system of claim 1, configured to determine a weight of the subject patent, wherein the weight is based on the age difference between the at least one prior art reference and the subject patent, and the average similarity between the subject patent and the at least one prior art reference.

7. The system of claim 1, configured to determine a weight of the subject patent, wherein the weight is based on the age difference between the at least one prior art reference and the subject patent, the average similarity between the subject patent and the at least one prior art reference, and the art classification of the prior at reference and the subject patent.

8. The system of claim 1, configured to determine a weight of the subject patent, wherein the weight is based on the age difference between the at least one prior art reference and the subject patent, the average similarity between the subject patent and the at least one prior art reference, the art classification of the prior at reference and the subject patent, and the original inventor of the prior art reference and the subject patent.

9. The system of claim 1, wherein a weight is determined in a manner that the age of a patent is indirectly proportional to its weight.

10. A method of valuating patents, the method comprising a network, the network comprising:
a plurality of nodes, each node configured to transact with at least one other node in the plurality of nodes;
a server, configured to communicate with at least one node in the plurality of nodes, the server comprising at least one hardware processor, a non-transitory machine-readable storage medium, the server configured to:
determine the number of times a subject patent is cited by at least one prior art patent reference determine the number of times a subject patent is cited by at least one prior art patent reference and store in memory said number of times a subject patent is cited;
compare patent claims in at least one prior art patent reference and the subject patent;
determine an age of at least one prior art patent reference and the subject patent;
determine a classification of at least one prior art reference and the subject patent; and
determine a maintenance fee status of the subject patent, wherein maintenance payment history is used to generate a model so a user may make critical decisions as to what patents said user may next visit and so historical patent value results may be evaluated by said hardware processor so that a user may be able to establish a patent value.

11. The network of claim 10, further configured to determine a weight for the subject patent based on its age, citing references, classification, maintenance fee status, and assignees.

12. The network of claim 10, configured to compare the age of the subject patent and the age of at least one prior art reference.

13. The network of claim 10, wherein the system is configured to determine the weight of the subject patent based on the difference in age between the subject patent and at the at least one prior art reference.

14. The network of claim 10, wherein the system is configured to determine the weight of the subject patent based on the difference in age between the subject patent and at the at least one prior art reference.

15. The network of claim 10, configured to determine the weight of the subject patent, wherein the weight is based on at least one prior art reference, and the age difference between the at least one prior art reference and the subject patent.

16. The network of claim 10, configured to determine a weight of the subject patent, wherein the weight is based on the age difference between the at least one prior art reference and the subject patent, and the average similarity between the subject patent and the at least one prior art reference.

17. The network of claim 10, configured to determine a weight of the subject patent, wherein the weight is based on the age difference between the at least one prior art reference and the subject patent, the average similarity between the subject patent and the at least one prior art reference, and the art classification of the prior at reference and the subject patent.

18. The network of claim 10, configured to determine a weight of the subject patent, wherein the weight is based on the age difference between the at least one prior art reference and the subject patent, the average similarity between the subject patent and the at least one prior art reference, the art classification of the prior at reference and the subject patent, and the original inventor of the prior art reference and the subject patent.

19. The network of claim 10, wherein a weight is determined in a manner that the age of a patent is indirectly proportional to its weight.
